(19) United States
(12) Patent Application Publication
(10) Pub. No.: US 2016/0377032 A1
(43) Pub. Date: Dec. 29, 2016

(54) VAPORIZED FUEL TREATMENT DEVICE

(71) Applicant: AISAN KOGYO KABUSHIKI KAISHA, Obu-shi (JP)

(72) Inventors: Junya KIMOTO, Obu (JP); Takanori AKIYAMA, Nagoya (JP); Hiroshi TAKAMATSU, Chiryu (JP)

(21) Appl. No.: 15/101,663

(22) PCT Filed: Sep. 4, 2014
(86) PCT No.: PCT/JP2014/073303

§ 371 Date: Jun. 3, 2016

(30) Foreign Application Priority Data
Dec. 17, 2013 (JP) 2013-260435

(51) Int. Cl. F02M 25/08

(52) U.S. Cl. CPC F02M 25/0854; F02M 25/0872

(57) ABSTRACT

A vaporized fuel treatment device has formed therein a passage (3) through which fluid can flow. The passage (3) comprises a primary chamber (21) which is provided with a primary adsorption layer (11) and a secondary chamber (22) which is located on the atmosphere port (6) side of the primary chamber (21). The secondary chamber (22) has a first adsorption layer (12), a second adsorption layer (13), and a third adsorption layer (14), which are provided serially from the primary adsorption layer (11) side. The secondary chamber (22) also has separation sections (31, 32) for separating the adjacent adsorption layers. With respect to the volume of the primary adsorption layer (11), the volume of the first adsorption layer (12) is set in the range of 4.0% to 8.5%, inclusive, the volume of the second adsorption layer (13) is set in the range of 1.2% to 3.0%, inclusive, and the volume of the third adsorption layer (14) is set in the range of 0.9% to 2.2%, inclusive. Consequently, the amount of blowing of vaporized fuel discharged from the atmosphere port to the atmosphere is reduced to a low level.

### TECHNICAL FIELD

The present invention relates to vaporized fuel treatment devices.

### BACKGROUND ART

Conventionally, a vaporized fuel treatment device (hereinafter referred to as a canister), which temporarily adsorbs fuel components in vaporized fuel, has been used to prevent vaporized fuel from discharging from a fuel tank or the like of an automobile.

Among such canisters, a known canister 101, as shown in FIG. 6, includes a case 105 provided with a tank port 102, a purge port 103, and an atmosphere port 104, in which the case 105 includes therein a primary chamber 106 communicating with the tank port 102 and the purge port 103, and a secondary chamber 107 communicating with the atmosphere port 104; the primary chamber 106 and the secondary chamber 107 communicate with each other on an opposite side to the atmosphere port 104; the primary chamber 106 includes therein a first adsorption layer 111 filled with activated carbon; the secondary chamber 107 includes therein a second adsorption layer 112, a third adsorption layer 113, and a fourth adsorption layer 114, which are provided in series and filled with the activated carbon; partition plates 121 and 122 are provided respectively between the second adsorption layer 112 and the third adsorption layer 113, and between the third adsorption layer 113 and the fourth adsorption layer 114 (refer to Patent Literature 1, for example).

The canister 101 is adapted so that vaporized fuel blowing off into the atmosphere is reduced by setting the volume of the fourth adsorption layer 114 to be smaller than those of the other adsorption layers 111, 112, and 113.

### CITATION LIST

### Patent Literature

### Patent Literature 1: JP-A-2002-235610

### SUMMARY OF INVENTION

### Technical Problem

In the canister 101 of a conventional art, only the volume of the fourth adsorption layer 114 is set, such as within a range from 2.0% to 4.8% of volume of the first adsorption layer 111. Even when the volume of the fourth adsorption layer 114 is set at that volume, blowing off of vaporized fuel to into the atmosphere may occur after purging if volume of the second adsorption layer 112 and the third adsorption layer 113 is too large or small.

It is an object of the present invention to provide a vaporized fuel treatment device that reduces vaporized fuel components blowing off into the outside from an atmosphere port more than conventional canisters.

### Solution to Problem

To solve the problem above, the present invention provides a vaporized fuel treatment device comprising: a passage provided inside to allow fluid to flow therethrough; a tank port and a purge port provided at one end of the passage; an atmosphere port provided at the other end of the passage; and four adsorption layers provided in the passage and filled with adsorbents capable of adsorbing fuel components,

the passage including: a primary chamber provided with a primary adsorption layer; and a secondary chamber provided on an atmosphere port side of the primary chamber,

the secondary chamber including: a first adsorption layer; a second adsorption layer; a third adsorption layer, the layers being provided in series in order from a primary adsorption layer side; and separation sections for separating the adsorption layers adjacent to each other,

wherein with respect to a volume of the primary adsorption layer, a volume of the first adsorption layer is set at not less than 4.0% and not more than 8.5% of the volume thereof; a volume of the second adsorption layer is set at not less than 1.2% and not more than 3.0% of the volume thereof; and a volume of the third adsorption layer is set at not less than 0.9% and not more than 2.2% of the volume thereof.

In the present invention, the volume of the second adsorption layer may be set at less than the volume of the first adsorption layer, and the volume of the third adsorption layer may be set at less than the volume of the second adsorption layer.

In the present invention, a total of the volumes of the adsorption layers may be set at less than a total of volumes of the separation sections in the secondary chamber.

In the present invention, the volume of each of the separation sections may be set to increase toward the atmosphere port in the secondary chamber.

In the present invention, an interval between the adsorption layers adjacent to each other may be set to increase toward the separation section closer to the atmosphere port.

In the present invention, the adsorption layer positioned closest to the atmosphere port in the secondary chamber may be composed of activated carbon with a butane working capacity of 14.5 g/dL or more according to ASTM D5228.

In the present invention, the adsorption layer provided closest to the tank port may be composed of pulverized coal in the vaporized fuel treatment device.

### Advantageous Effects of Invention

In the present invention, there are provided four adsorption layers, and with respect to a volume of the primary adsorption layer, the volume of the first adsorption layer is set at not less than 4.0% and not more than 8.5% of volume of the primary adsorption layer, the volume of the second adsorption layer is set at not less than 1.2% and not more than 3.0% of the volume thereof; the volume of the third adsorption layer is set at not less than 0.9% and not more than 2.2% of the volume thereof. As a result, desorption performance can be improved more than the conventional canister 101 to reduce vaporized fuel blowing off into the atmosphere, and performance of preventing vaporized fuel from blowing off can be improved accordingly.

### BRIEF DESCRIPTION OF DRAWINGS

FIG. 1 is a schematic view illustrating a vaporized fuel treatment device in accordance with a first embodiment of the present invention.

FIG. 2 is a schematic view illustrating a vaporized fuel treatment device in accordance with a second embodiment of the present invention.

FIG. 3 is a schematic view illustrating a vaporized fuel treatment device in accordance with a third embodiment of the present invention.

FIG. 4 is a schematic view illustrating a vaporized fuel treatment device in accordance with a fourth embodiment of the present invention.

FIG. 5 is a schematic view illustrating a vaporized fuel treatment device in accordance with a fifth embodiment of the present invention.

FIG. 6 is a schematic sectional view showing structure of a conventional vaporized fuel treatment device.

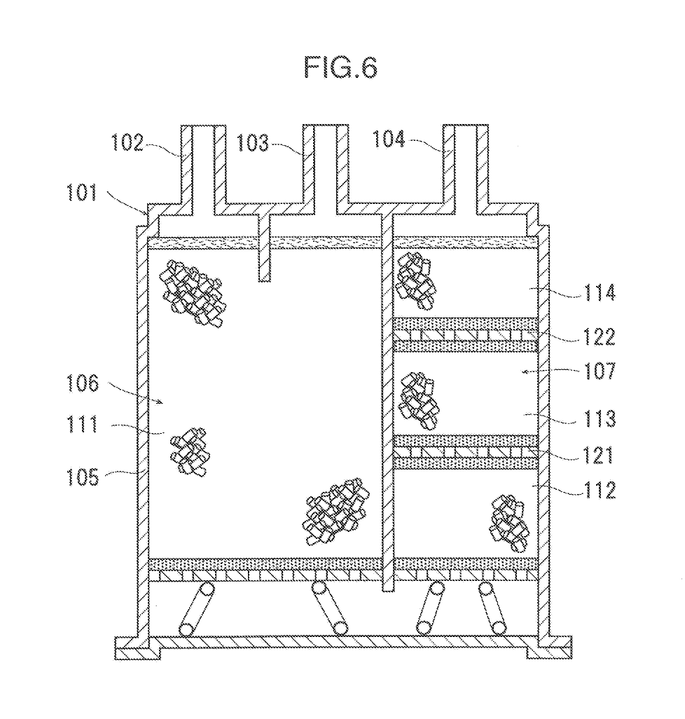

### DESCRIPTION OF EMBODIMENTS

Embodiments of the present invention will be described with reference to accompanying drawings.

### First Embodiment

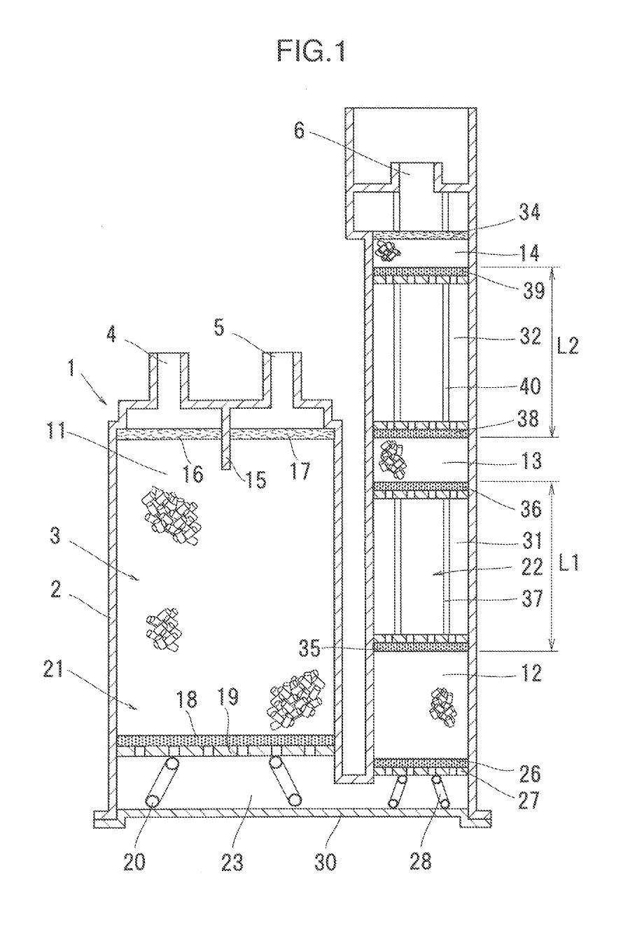

FIG. 1 shows a first embodiment of the present invention,

A vaporized fuel treatment device 1 of the present invention, as shown in FIG. 1, includes a case 2, inside of which a passage 3 is provided to allow fluid to flow therethrough. In the case 2, a tank port 4 and a purge port 5 are provided at one end of the passage 3 therein, and an atmosphere port 6 is provided at the other end thereof.

The passage 3 includes therein four adsorption layers filled with adsorbents capable of adsorbing vaporized fuel components, namely, a primary adsorption layer 11, a first adsorption layer 12, a second adsorption layer 13, and a third adsorption layer 14, arranged in series. The present embodiment uses activated carbon as the adsorbents.

In the case 2, as shown in FIG. 1, there are provided a primary chamber 21 communicating with the tank port 4 and the purge port 5, and a secondary chamber 22 communicating with the atmosphere port 6. The primary chamber 21 and the secondary chamber 22 communicate with each other through a space 23 provided inside the case 2 on a side opposite to the atmosphere port 6. When gas flows in the passage 3, the gas turns back its direction in the space 23 to form a substantially U-shape flow.

The tank port 4 communicates with an upper air chamber of a fuel tank (not shown), and the purge port 5 is connected to an air intake passage of the engine through a purge control valve (VSV, not shown). Opening of the purge control valve is controlled by an electronic control unit (ECU), and purge control is performed during engine operation on the basis of a measurement value, for example, of an A/F sensor, or the like. The atmosphere port 6 communicates with the outside through a passage (not shown).

The primary chamber 21 is filled with activated carbon, which is an adsorbent, at a predetermined density so that the primary adsorption layer 11 is formed. The primary adsorption layer 11 is set at the largest volume among the four adsorption layers 11, 12, 13, and 14. Although formed activated carbon, pulverized coal or the like can be used for the activated carbon in the primary adsorption layer 11, the present embodiment uses pulverized coal.

Between the tank port 4 and the purge port 5 in the case 2, a baffle plate 15 is provided which extends from an inner face of the case 2 to a part of the primary adsorption layer 11. The baffle plate 15 allows fluid flowing between the tank port 4 and the purge port 5 to flow through the primary adsorption layer 11.

The primary adsorption layer 11 is covered with a filter 16 made of nonwoven fabric on its tank port 4 side, and is covered with a filter 17 made of nonwoven fabric on its purge port 5 side. The primary adsorption layer 11 includes, on its face on a space 23 side, a filter 18 made of urethane or the like such that the entire face is covered with the filter 18. Below the filter 18, a plate 19 with a large number of communication holes is provided. The plate 19 is urged by urging means 20, such as a spring, toward the tank port 4.

The secondary chamber 22 includes, on its space 23 side, the first adsorption layer 12 filled with activated carbon, which is an adsorbent, at a predetermined density. Although formed activated carbon, pulverized coal or the like can be used for the activated carbon, the present embodiment uses formed activated carbon.

The first adsorption layer 12 includes, on its space 23 side, a filter 26 made of urethane or the like such that the entire portion is covered with the filter 26. The filter 26 is provided on its space 23 side with a plate 27 with a large number of communication holes that are substantially uniformly provided in the whole area of the plate 27. The plate 27 is urged by an urging member 28, such as a spring, toward an atmosphere port 6 side.

The space 23 is formed between the plates 19 and 27, and a lid plate 30 of the case 2. The primary adsorption layer 11 and the first adsorption layer 12 communicate with each other through the space 23.

The secondary chamber 22 includes, on the atmosphere port 6 side of the first adsorption layer 12, the second adsorption layer 13 filled with activated carbon, which is an adsorbent, at a predetermined density. Although formed activated carbon, pulverized coal or the like may be used for the activated carbon, the present embodiment uses formed activated carbon.

Between an end face of the first adsorption layer 12 on the atmosphere port 6 side and an end face of the second adsorption layer 13 on the space 23 side, a first separation section 31 is provided to separate the adsorption layers 12 and 13 at a predetermined interval L1.

The first separation section 31 includes, on its first adsorption layer 12 side and second adsorption layer 13 side, filters 35 and 36 made of urethane or the like at ends, respectively, such that the entire ends are covered with the respective filters. Between the filters 35 and 36, space forming members 37 are provided to allow the filters 35 and 36 to be separated at a predetermined interval.

The secondary chamber 22 includes, on the atmosphere port 6 side of the second adsorption layer 13, the third adsorption layer 14 filled with activated carbon, which is an adsorbent, at a predetermined density. Although formed activated carbon, pulverized coal or the like may be used for the activated carbon, the present embodiment uses high-performance activated carbon with a butane working capacity (BWC) of 14.5 g/dL or more according to ASTM D5228. The third adsorption layer 14 is provided at its end on the atmosphere port 6 side with a filter 34 made of nonwoven fabric or the like such that the entire face of the end is covered with the filter 34.

Between an end face of the second adsorption layer 13 on the atmosphere port 6 side and an end face of the third adsorption layer 14 on the space 23 side, a second separation section 32 is provided to separate the adsorption layers 13 and 14 at a predetermined interval L2.

The second separation section 32 includes, at ends on its second adsorption layer 13 side and third adsorption layer 14 side, filters 38 and 39 made of urethane or the like, respectively, such that the entire ends are covered with the respective filters. Between the filters 38 and 39, space forming members 40 are provided to allow the filters 38 and 39 to be separated at a predetermined interval.

No adsorbent is provided in the separation sections 31 and 32. The separation sections 31 and 32 may be used to separate the adsorption layers adjacent to each other at a predetermined interval, and thus, for example, may be composed of a filter made of urethane or the like, or only the space forming members 37 and 40, respectively.

With respect to a volume V0 of the primary adsorption layer 11, a volume V1 of the first adsorption layer 12 is set at not less than 4.0% and not more than 8.5% of the volume V0. A volume V2 of the second adsorption layer 13 is set at not less than 1.2% and not more than 3.0% of the volume V0. A volume V3 of the third adsorption layer 14 is set at not less than 0.9% and not more than 2.2% of the volume V0. If the volume of any one of the adsorption layers 12, 13, and 14 is increased beyond the corresponding ones of the ranges above, the amount of residual vaporized fuel components increases after a purge in the adsorption layer. As a result, the amount of vaporized fuel components leaked from the adsorption layer to a downstream side increases to cause the amount of vaporized fuel blowing off into the atmosphere to increase, thereby deteriorating performance of preventing vaporized fuel from blowing off. If the volume of any one of the adsorption layers 12, 13, and 14 is reduced below the corresponding ones of the ranges above, sufficient adsorption performance for vaporized fuel components cannot be achieved in the adsorption layer to cause the amount of vaporized fuel blowing off into the atmosphere to increase, thereby deteriorating the performance of preventing vaporized fuel from blowing off.

The volumes are set so that the volume V2 of the second adsorption layer 13 is less than the volume V1 of the first adsorption layer 12, and the volume V3 of the third adsorption layer 14 is less than the volume V2 of the second adsorption layer 13. That is, the volumes of the respective adsorption layers in the secondary chamber 22 are set so as to decrease toward the atmosphere port 6 side.

In addition, a volume V5 of the second separation section 32 is set at more than a volume V4 of the first separation section 31. That is, the volumes of the separation sections in the secondary chamber 22 are set to increase toward the atmosphere port 6 side.

Further, a total of the volumes (V1+V2+V3) of the adsorption layers 12, 13, and 14 in the secondary chamber 22 is set at less than a total of the volumes (V4+V5) of the separation sections 31 and 32 in the secondary chamber 22.

The interval L2 between the second adsorption layer 13 and the third adsorption layer 14 is set at more than the interval L1 between the first adsorption layer 12 and the second adsorption layer 13. That is, an interval between the adsorption layers adjacent to each other in the secondary chamber 22 is set so that the separation section closer to the atmosphere port 6 has a longer interval.

Although the cross-sectional areas of the first adsorption layer 12, the second adsorption layer 13, and the third adsorption layer 14 orthogonal to the axis of them may be set in any manner, for example, set at the same value, it is preferable that the adsorption layer closer to the atmosphere port 6 has a smaller cross-sectional area.

In the structure described above, gas including vaporized fuel, flowing into the vaporized fuel treatment device 1 from the tank port 4, passes through adsorbents in each of the adsorption layers 11 to 14 which adsorb the fuel component, and then the gas is discharged into the atmosphere from the atmosphere port 6.

In purge control during engine operation, the electronic control unit (ECU) allows the purge control valve to open so that air sucked into the vaporized fuel treatment device 1 from the atmosphere port due to a negative pressure in the air intake passage flows in a direction opposite to the above to be supplied to the air intake passage of the engine from the purge port 5. Then, fuel components adsorbed in the adsorbents in each of the adsorption layers 11 to 14 are desorbed to be supplied to the engine along with air.

Next, a method of measuring the amount of vaporized fuel blowing off in the vaporized fuel treatment device 1 will be described. First, a predetermined amount of vaporized gasoline components is allowed to flow into the vaporized fuel treatment device 1 from the tank port 4, and then is left for a time period long enough until adsorption and desorption of vaporized fuel components in the adsorbents are stabilized. After purge is performed, the adsorbents are left for a predetermined time. Next, butane is allowed to flow into the vaporized fuel treatment device 1 from the tank port 4 to be adsorbed in the adsorbents and is left until temperature of the adsorbents becomes constant. Then, purge is performed, and the adsorbents are left for half a day. Subsequently, the vaporized fuel treatment device 1 is connected to a gasoline tank, and the amounts of vaporized fuel blowing off are the measured while changing the temperature so as to simulate change in outside-air temperature. The amount of vaporized fuel blowing off is derived by detecting HC concentration of gas discharged from the atmosphere port 6 and converting the HC concentration into weight.

The amount of vaporized fuel blowing off was measured by changing the volume of each of the adsorption layers 11 to 14 while a reference value of the amount of vaporized fuel blowing off was set at 25 mg.

In the case where with respect to the volume V0 of the primary adsorption layer 11, the volume V1 of the first adsorption layer 12 was set at 6.6% of the volume V0, the volume V2 of the second adsorption layer 13 was set at 2.2% of the volume V0 and the volume V3 of the third adsorption layer 14 was set at 1.1% of the volume V0, the amount of vaporized fuel blowing off was 19 mg less than the reference value.

In the case where with respect to the volume V0 of the primary adsorption layer 11, the volume V1 of the first adsorption layer 12 was set at 7.0% of the volume V0, the volume V2 of the second adsorption layer 13 was set at 2.3% of the volume V0 and the volume V3 of the third adsorption layer 14 was set at 1.2% of the volume V0, the amount of vaporized fuel blowing off was 23 mg less than the reference value.

In the case Where with respect to the volume V0 of the primary adsorption layer 11, the volume V1 of the first adsorption layer 12 was set at 4.0% of the volume V0, the volume V2 of the second adsorption layer 13 was set at 1.3% of the volume V0 and the volume V3 of the third adsorption layer 14 was set at 1.0% of the volume V0, the amount of vaporized fuel blowing off was 17 mg less than the reference value.

In this way, in the case where with respect to the volume V0 of the primary adsorption layer 11, the volume V1 of the first adsorption layer 12 was set at not less than 4.0% and not more than 8.5% of the volume V0, the volume V2 of the second adsorption layer 13 was set at not less than 1.2% and not more than 3.0% of the volume V0, and the volume V3 of the third adsorption layer 14 was set at not less than 0.9% and not more than 2.2% of the volume V0, the amount of vaporized fuel blowing off was the reference value or less.

In contrast, in the case where with respect to the volume V0 of the primary adsorption layer 11, the volume V1 of the first adsorption layer 12 was set at 10.0% of the volume V0, the volume V2 of the second adsorption layer 13 was set at 1.3% of the volume V0 and the volume V3 of the third adsorption layer 14 was set at 0.4% of the volume V0, the amount of vaporized fuel blowing off was 90 mg greatly exceeding the reference value.

In the case where with respect to the volume V0 of the primary adsorption layer 11, the volume V1 of the first adsorption layer 12 was set at 5.0% of the volume V0, the volume V2 of the second adsorption layer 13 was set at 1.4% of the volume V0 and the volume V3 of the third adsorption layer 14 was set at 0.5% of the volume V0, the amount of vaporized fuel blowing off was 110 mg greatly exceeding the reference value.

In this way, in the case where at least any one of the adsorption layers 12, 13, and 14 does not satisfy the corresponding ones of the following conditions: with respect to the volume V0 of the primary adsorption layer 11, the volume V1 of the first adsorption layer 12 was set at not less than 4.0% and not more than 8.5% of the volume V0; the volume V2 of the second adsorption layer 13 was set at not less than 1.2% and not more than 3.0% of the volume V0; and the volume V3 of the third adsorption layer 14 was set at not less than 0.9% and not more than 2.2% of the volume V0, the amount of vaporized fuel blowing off greatly exceeded the reference value.

The vaporized fuel treatment device 1 of the present invention has the structure and configuration described above to achieve operation and effect below.

The volume of each of the adsorption layers can be optimized by setting, with respect to the volume V0 of the primary adsorption layer 11, the volume V1 of the first adsorption layer 12 at not less than 4.0% and not more than 8.5% of the volume V0, the volume V2 of the second adsorption layer 13 at not less than 1.2% and not more than 3.0% of the volume V0, and the volume V3 of the third adsorption layer 14 at not less than 0.9% and not more than 2.2% of the volume V0. As a result, desorption performance can be improved more than the conventional canister 101, and vaporized fuel blowing off into the atmosphere can be reduced to improve performance of preventing vaporized fuel from blowing off.

In the case where the volume of each of the adsorption layers in the secondary chamber 22 is set so that the adsorption layer closer to the atmosphere port 6 has a smaller volume, the adsorption layer closer to the atmosphere port 6 has a less amount of residual fuel components after purge. As a result, vaporized fuel blowing off into the atmosphere can be reduced to improve performance of preventing vaporized fuel from blowing off.

A total of the volumes (V1+V2+V3) of the adsorption layers 12, 13, and 14 in the secondary chamber 22 is set at less than a total of the volumes (V4+V5) of the separation sections 31 and 32, and thus residence time of gas at a temperature lowered due to desorption of vaporized fuel components in each of the adsorption layers, in each of the separation sections can be increased more than the conventional canister 101. As a result, the temperature of the gas, once lowered due to the desorption, is subject to enhanced temperature rises (recovery). This enables temperature of gas flowing into the adsorption layer positioned on the tank port 4 side among the adsorption layers to increase more than the conventional canister 101, thereby enabling performance of the adsorbents of desorbing vaporized fuel components to be maintained at a high level. As a result, the amount of residual fuel components in the vaporized fuel treatment device 1 after purge can be reduced more than the conventional canister 101, and thus the amount of vaporized fuel blowing off into the atmosphere can be reduced to improve performance of preventing vaporized fuel from blowing off.

The interval L2 between the second adsorption layer 13 and the third adsorption layer 14 is set at longer than the interval L1 between the first adsorption layer 12 and the second adsorption layer 13, and thus residence time of gas in the separation section closer to the atmosphere port 6 can be increased. As a result, the temperature of the gas, once lowered due to the desorption of vaporized fuel components when being purged, is subject to enhanced temperature rises to improve desorption performance of the vaporized fuel treatment device 1.

### Second Embodiment

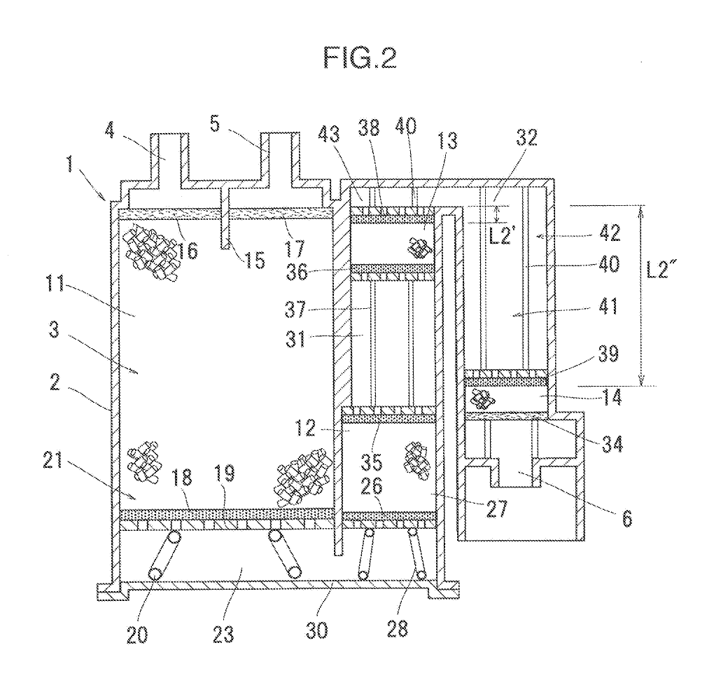

While in the first embodiment, the U-shaped passage 3, which turns back its direction once in the space 23, is provided in the case 2, an N-shaped passage 41, which turns back its direction twice may be provided in the case 2, for example, as shown in FIG. 2.

Structure of the primary chamber 21 of the present second embodiment is similar to that of the primary chamber 21 of the first embodiment. A secondary chamber 42 of the present second embodiment is formed in a U-shape turning back its direction in a space 43. The secondary chamber 42 includes one end communicating with the space 23, and the other end provided with the atmosphere port 6.

Between the spaces 23 and 43 in the secondary chamber 42, the first adsorption layer 12 and the second adsorption layer 13, which are similar to those of the first embodiment, are provided. Between the first adsorption layer 12 and the second adsorption layer 13, the first separation section 31 is provided. The third adsorption layer 14, which is similar to the third adsorption layer 14 of the first embodiment, is provided in the space 43 on the atmosphere port 6 side. Between the third adsorption layer 14 and the second adsorption layer 13, the second separation section 32 is provided.

A relationship between the adsorption layers 11, 12, 13, and 14, and the separation sections 31 and 32, is set in a similar manner to the first embodiment. An axial interval between an end face of the second adsorption layer 13 on the atmosphere port 6 side and an end face of the third adsorption layer 14 on the tank port 4 side in the second embodiment corresponds to the interval L2 between the second adsorption layer 13 and the third adsorption layer 14 in the first embodiment. That is, as shown in FIG. 2, the interval L2 corresponds to a total (L2′+L2″) of an interval L2′ between the end face of the second adsorption layer 13 on the atmosphere port 6 side and an end face in the space 43 on the tank port 5 side, and an interval L2″ between an end face in the space 43 on the atmosphere port 6 side and an end face of third adsorption layer 14 on the tank port 4 side.

Other members are similar to those of the first embodiment, and thus the member similar to that in the first embodiment is designated by the same reference numeral to omit description of the member. The present second embodiment also achieves similar operation and effect to the first embodiment.

### Third Embodiment

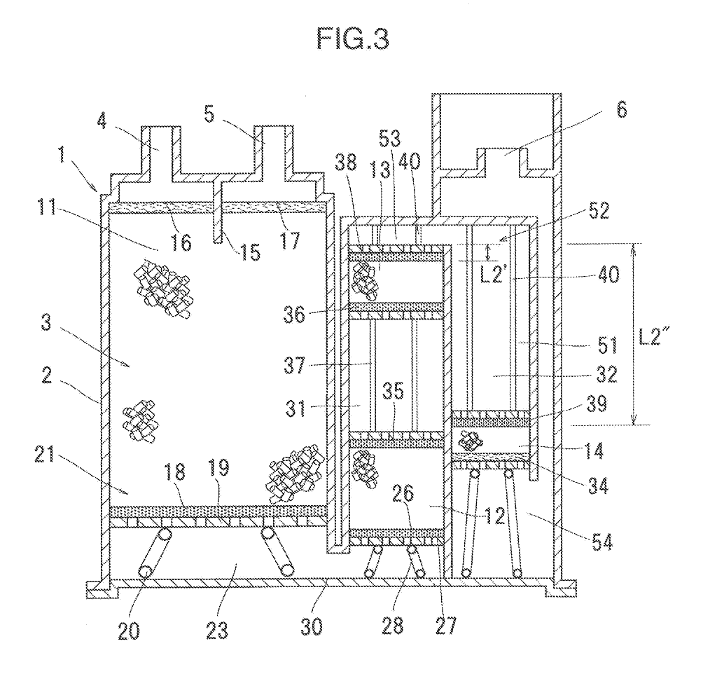

A passage in the case 2 may be formed in a shape different from the passages 3 and 41 provided in the first and second embodiments, respectively, and thus, a passage 51 formed in a W-shape turning back its direction three times in the case 2 may be provided, for example, as shown in FIG. 3.

Structure of the primary chamber 21 of the present third embodiment is similar to that of the primary chamber 21 of the first embodiment. A secondary chamber 52 of the present third embodiment is formed in an N-shape turning back its direction twice in spaces 53 and 54. The secondary chamber 52 includes one end communicating with the space 23, and the other end provided with the atmosphere port 6.

Between the spaces 23 and 53 in the secondary chamber 52, the first adsorption layer 12 and the second adsorption layer 13, which are similar to those of the first embodiment, are provided. Between the first adsorption layer 12 and the second adsorption layer 13, the first separation section 31 is provided. In addition, between the spaces 53 and 54, the third adsorption layer 14, which is similar to the third adsorption layer 14 of the second embodiment, is provided. Between the third adsorption layer 14 and the second adsorption layer 13, the second separation section 32 is provided.

A relationship between the adsorption layers 11, 12, 13, and 14, and the separation sections 31 and 32, is set in a similar manner to the second embodiment.

Other members are similar to those of the first and second embodiments, and thus the member similar to the above ones is designated by the same reference numeral to omit description of the member. The present third embodiment also achieves similar operation and effect to those in the first and second embodiments.

### Fourth Embodiment

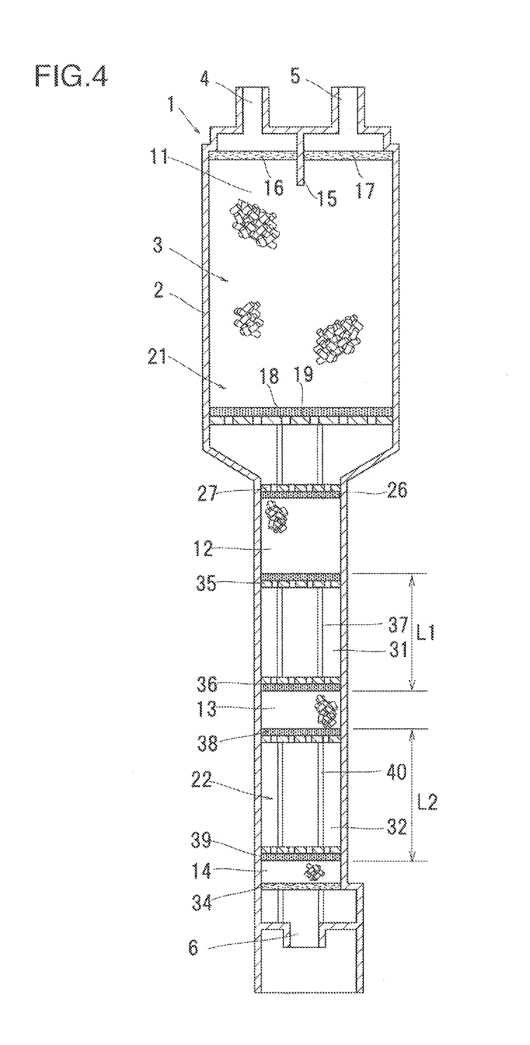

While the first embodiment includes the U-shaped passage 3 turning back its direction once in the space 23 provided in the case 2, an I-shaped passage without turning back its direction may be provided in a case, for example, as shown in FIG. 4.

The present fourth embodiment, for example, as shown in FIG. 4, is a vaporized fuel treatment device including the primary chamber 21 and the secondary chamber 22 that are arranged linearly without turning back its direction in a space.

The present fourth embodiment also includes a secondary chamber having three adsorption layers, and separation sections each separating the adsorption layers adjacent to each other, and the secondary chamber is provided on the atmosphere port 6 side of the primary adsorption layer 11.

A relationship between the adsorption layers 11, 12, 13, and 14, and the separation sections 31 and 32, is set in a similar manner to the first embodiment.

Other members are similar to those of the first embodiment, and thus the member similar to the above ones is designated by the same reference numeral to omit description of the member. The present fourth embodiment also achieves similar operation and effect to those in the first embodiment.

### Fifth Embodiment

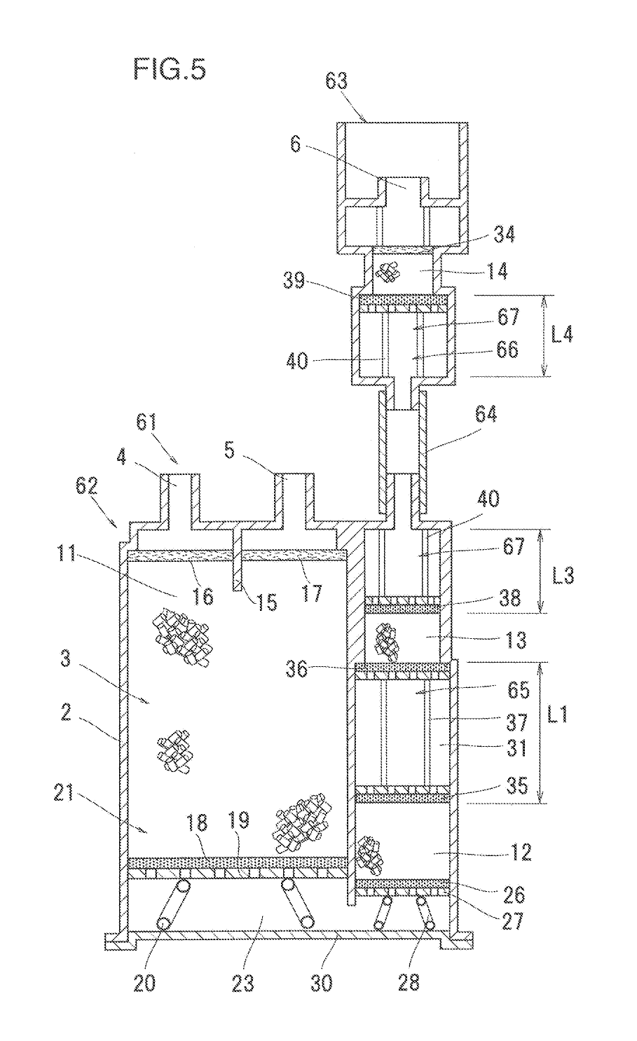

FIG. 5 shows a fifth embodiment in accordance with the present invention.

A vaporized fuel treatment device 61 of the present fifth embodiment includes a main canister 62, and a sub-canister 63. The main canister 62 and the sub-canister 63 communicate with each other through a communication pipe 64.

The main canister 62, as with the first embodiment, is provided inside with the primary chamber 21 and a first secondary chamber 65. The primary chamber 21 is provided inside with the primary adsorption layer 11, and the first secondary chamber 65 is provided inside with the first adsorption layer 12 and the second adsorption layer 13 that are similar to those of the first embodiment. Between the first adsorption layer 12 and the second adsorption layer 13, the first separation section 31 is provided.

The sub-canister 63 is provided inside with a second secondary chamber 66, and the second secondary chamber 66 is provided inside with the third adsorption layer 14 that is similar to that of the first embodiment. Between the second adsorption layer 13 and the third adsorption layer 14, a second separation section 67 is provided from the second secondary chamber 66 toward the first secondary chamber 65.

The first secondary chamber 65 in the main canister 62 and the second secondary chamber 66 in the sub-canister 63 correspond to the secondary chamber of the first embodiment.

A relationship between the adsorption layers 11, 12, 13, and 14, and the separation sections 31 and 32, is set in a similar manner to the first embodiment In this relationship, since among the volume of the second separation section 67, the section consisting of the communication pipe 64 has a smaller cross-sectional area, and hence increased flow velocity and shorter residence time, it is preferable that the adsorption layers 11, 12, 13, and 14, and the separation sections 31 and 67 are designed so that the spaces obtained by subtracting the space of the communication pipe 64 from the space of the second separation section 67 have distances or volumes which satisfy the relationship of the first embodiment. For example, the interval L2 between the second adsorption layer 13 and the third adsorption layer 14 in the first embodiment corresponds to L3+L4 in FIG. 5.

Other members are similar to those of the first embodiment, and thus the member similar to the above ones is designated by the same reference numeral to omit description of the member. The present fifth embodiment also achieves similar operation and effect to those in the first embodiment.

### Another Embodiment

If a relationship between the adsorption layers 11, 12, 13, and 14, and the separation sections 31 and 32, is set similar to the first embodiment, a shape of the whole of a vaporized fuel treatment device, and shapes and arrangements of adsorption layers, separation sections, spaces, and the like, can be set in any manner other than the embodiments above.

### REFERENCE SIGNS LIST

1, 61 . . . vaporized fuel treatment device
3, 41, 51 . . . passage
4 . . . tank port
5 . . . purge port
6 . . . atmosphere port
11, 12, 13, 14 . . . adsorption layer
22, 42, 52, 65, 66 . . . secondary chamber
31, 32, 67 . . . separation section

1. A vaporized fuel treatment device comprising: a passage provided inside to allow fluid to flow therethrough; a tank port and a purge port provided at one end of the passage; an atmosphere port provided at the other end of the passage; and four adsorption layers provided in the passage and filled with adsorbents capable of adsorbing fuel components,
the passage including: a primary chamber provided with a primary adsorption layer; and a secondary chamber provided on an atmosphere port side of the primary chamber,
the secondary chamber including: a first adsorption layer; a second adsorption layer; a third adsorption layer, the layers being provided in series in order from a primary adsorption layer side; and separation sections for separating the adsorption layers adjacent to each other,
wherein with respect to a volume of the primary adsorption layer, a volume of the first adsorption layer is set at not less than 4.0% and not more than 8.5% of the volume thereof; a volume of the second adsorption layer is set at not less than 1.2% and not more than 3.0% of the volume thereof; and a volume of the third adsorption layer is set at not less than 0.9% and not more than 2.2% of the volume thereof.

2. The vaporized fuel treatment device according to claim 1, wherein the volume of the second adsorption layer is set at less than the volume of the first adsorption layer, and the volume of the third adsorption layer is set at less than the volume of the second adsorption layer.

3. The vaporized fuel treatment device according to claim 1, Wherein a total of the volumes of the adsorption layers is set at less than a total of volumes of the separation sections in the secondary chamber.

4. The vaporized fuel treatment device according to claim 1, wherein the volume of each of the separation sections is set to increase toward the atmosphere port in the secondary chamber.

5. The vaporized fuel treatment device according to claim 1, wherein an interval between the adsorption layers adjacent to each other is set to increase toward the separation section closer to the atmosphere port in the secondary chamber.

6. The vaporized fuel treatment device according to claim 1, wherein the adsorption layer positioned closest to the atmosphere port in the secondary chamber is composed of activated carbon with a butane working capacity of 14.5 g/dL or more according to ASTM D5228.

7. The vaporized fuel treatment device according to claim 1, wherein the adsorption layer provided closest to the tank port is composed of pulverized coal in the vaporized fuel treatment device.
